(19) United States
(12) Patent Application Publication
(10) Pub. No.: US 2020/0327471 A1
(43) Pub. Date: Oct. 15, 2020

(54) MANAGEMENT DEVICE, MANAGEMENT METHOD, AND MANAGEMENT PROGRAM

(71) Applicant: TOYOTA JIDOSHA KABUSHIKI KAISHA, Toyota-shi (JP)

(72) Inventors: Naoko YOSHIZAWA, Nagoya-shi (JP); Takumi FUKUNAGA, Nagoya-shi (JP); Shinichirou FUJII, Kawasaki-shi (JP); Hiromitsu FUJII, Kariya-shi (JP)

(73) Assignee: TOYOTA JIDOSHA KABUSHIKI KAISHA, Toyota-shi (JP)

(21) Appl. No.: 16/817,945

(22) Filed: Mar. 13, 2020

(30) Foreign Application Priority Data
Apr. 11, 2019 (JP) 2019-075755

(51) Int. Cl. G06Q 10/06; G06Q 20/08; G06Q 10/08; G06Q 20/12

(52) U.S. Cl. CPC G06Q 10/06315; G06Q 20/085; G06Q 20/127; G06Q 10/06312; G06Q 10/0838

(57) ABSTRACT

A management device includes a memory and a processor having at least of one piece of hardware. The processor is configured to send a reconfirmation notification on a storage time limit to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package.

### INCORPORATION BY REFERENCE

The disclosure of Japanese Patent Application No. 2019-075755 filed on Apr. 11, 2019 including the specification, drawings and abstract is incorporated herein by reference in its entirety.

### BACKGROUND

### 1. Technical Field

The present disclosure relates to a management device, a management method, and a management program.

### 2. Description of Related Art

There is a technique in which, for use when a deliveryman collects and delivers packages, the trunk of a typical passenger car, registered in advance as a package receiving vehicle, is used as the reception/delivery position for a delivery package (for example, see Japanese Unexamined Patent Application Publication No. 2006-206225 (JP 2006-206225 A)). In this technique, when collecting and delivering packages, the authentication processing is performed between the collection/delivery communication device of a collection/delivery company and the vehicle communication device mounted on a specified vehicle and, when the authentication is successful, the trunk of the specified vehicle can be locked and unlocked.

### SUMMARY

However, the technique disclosed in JP 2006-206225 A described above does not consider how to deal with a situation in which the storage time limit of a package in the vehicle cabin of the package receiving vehicle approaches but the package is not yet collected.

The present disclosure provides a management device, a management method, and a management program that can deal appropriately with a situation in which the storage time limit of a package stored in the vehicle cabin of the package receiving vehicle approaches.

A management device according to the present disclosure includes a memory and a processor having at least one piece of hardware. The processor is configured to send a reconfirmation notification on a storage time limit to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package.

The processor may be configured to start charging processing for the client when the storage time limit is exceeded while the vehicle stores the package.

This configuration reduces the possibility that the storage time limit is exceeded since a client is charged as a penalty for exceeding the storage time limit.

The processor may be configured to select a transfer candidate vehicle based on parking/stopping information and to send a transfer possibility inquiry to a candidate terminal associated with a provider of the selected transfer candidate vehicle when a transfer request for transferring the package is received from a provider terminal associated with a provider of the vehicle, wherein the parking/stopping information includes information on positions and parking/stopping states of a plurality of vehicles each of which can provide a vehicle cabin thereof for receiving other person's packages in the area.

This configuration ensures the effective use of a vehicle registered as a package receiving vehicle in a predetermined area and allows the provider of the vehicle cabin to deal appropriately with a situation in which an abnormal situation is likely to occur, since the provider of the vehicle cabin sends a request for transferring the package to one of the other vehicles when the storage time limit approaches but the package is not collected.

The processor may be configured to further refer to schedule information for selecting the transfer candidate vehicle wherein the schedule information is registered by each of owners of the plurality of vehicles.

This configuration allows an appropriate vehicle to be selected according to the schedule of the owner of a vehicle and prevents an error that occurs when the vehicle is not present in the area.

The memory may be configured to store history information on past transfers and the processor may be configured to further refer to the history information for selecting the transfer candidate vehicle.

This configuration allows the transfer candidate vehicle to be efficiently selected considering the history information on past transfers.

The processor may be configured to select the transfer candidate vehicle according to a type of the package.

This configuration allows an appropriate vehicle to be selected according to the type of a package.

The processor may be configured to send a transfer instruction to a deliveryman terminal when a transfer acceptance notification is received from the candidate terminal, wherein the transfer instruction includes information on the transfer candidate vehicle and the deliveryman terminal is associated with a deliveryman of the package.

This configuration sends the transfer instruction to the deliveryman terminal to allow the transfer information to be transmitted reliably to the deliveryman.

A management method according to the present disclosure is a management method performed by a management device including a memory and a processor having at least one piece of hardware. The management method includes sending a reconfirmation notification on a storage time limit to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package wherein the storage time limit is read from the memory.

A management program according to the present disclosure is a management program causing a management device including a memory and a processor having at least one piece of hardware to perform sending a reconfirmation notification on a storage time limit to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package.

According to the present disclosure, a reconfirmation notification on a storage time limit is sent to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package. Therefore, this configuration allows the client to be aware that the package storage time limit approaches, making it possible for the client to deal appropriately with a situation in which the storage time limit approaches.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a diagram showing an outline of a collection/delivery system that includes a management device according to a first embodiment;

FIG. 2 is a block diagram showing a functional configuration of the collection/delivery system that includes the management device according to the first embodiment;

FIG. 3 is a diagram schematically showing parking/stopping information stored in the management device according to the first embodiment;

FIG. 4 is a flowchart showing an outline of processing performed by the management device according to the first embodiment;

FIG. 5 is a sequence diagram showing an outline of processing performed by the collection/delivery system after the management device according to the first embodiment sends a charging start notification to a client terminal;

FIG. 6 is a sequence diagram showing an outline of processing performed by a collection/delivery system that includes a management device according to a second embodiment and showing an outline of processing of locking a vehicle after a client collects a package;

FIG. 7 is a block diagram showing a functional configuration of a collection/delivery system that includes a management device according to a modification of the first embodiment;

FIG. 8 is a diagram showing a functional configuration of a collection/delivery system that includes the management device according to the second embodiment;

FIG. 9 is a diagram schematically showing parking/stopping information stored in the management device according to the second embodiment;

FIG. 10 is a sequence diagram showing an outline of processing performed by the collection/delivery system that includes the management device according to the second embodiment; and

FIG. 11 is a diagram schematically showing updated parking/stopping information stored in the management device according to the second embodiment.

### DETAILED DESCRIPTION OF EMBODIMENTS

A mode in which the present disclosure is carried out (hereinafter referred to as “embodiment”) will be described with reference to the accompanying drawings.

### First Embodiment

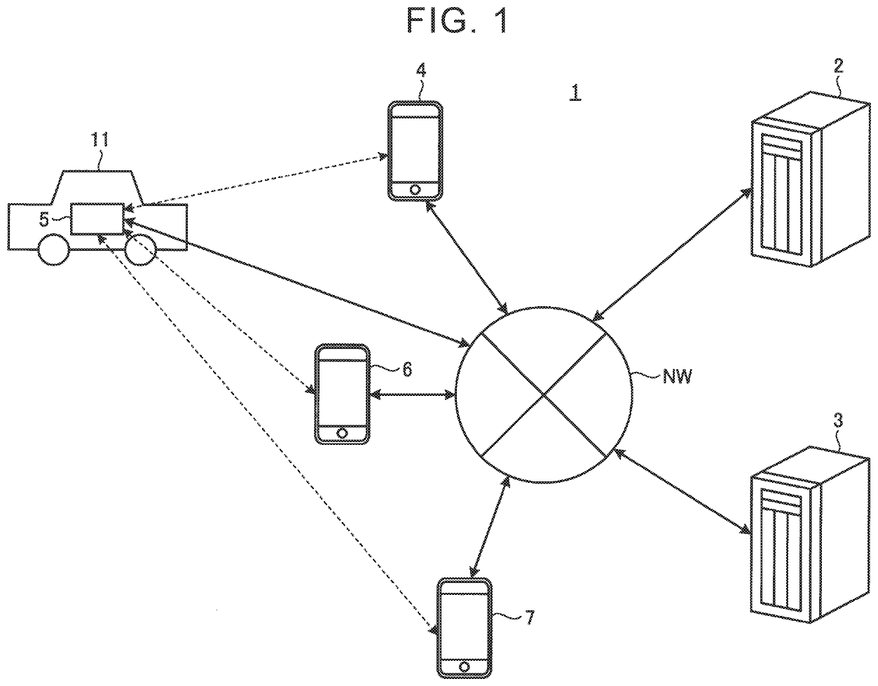

FIG. 1 is a diagram showing an outline of a collection/delivery system that includes a management device according to a first embodiment. A collection/delivery system 1 shown in FIG. 1 is a system in which the vehicle cabin of a vehicle 11, which is parked or stopped in a predetermined area and is registered in advance as a package receiving vehicle, is used to collect or deliver a package. The vehicle cabin of the vehicle 11 is the trunk or the boarding space of the vehicle 11. The area is a closed area such as a parking lot where the vehicle 11 is parked, but is not limited thereto.

The collection/delivery system 1 includes a management device 2 that manages the collection/delivery of packages, a center server 3 that manages the opening and closing of the doors of the vehicle 11, a deliveryman terminal 4 associated with a deliveryman, an in-vehicle device 5 mounted on the vehicle 11, a client terminal 6 associated with the collection/delivery client of a package, and a provider terminal 7 associated with a provider who owns the vehicle 11 and provides the vehicle cabin for receiving a package. The management device 2, center server 3, deliveryman terminal 4, in-vehicle device 5, client terminal 6, and provider terminal 7 are connected to the communication network NW for communicating with each other. In addition, the deliveryman terminal 4, client terminal 6, and provider terminal 7 are communicably connected to the in-vehicle device 5 via short-range wireless communication. The communication network NW is one of a local area network (LAN), a wide area network (WAN), a public network, a virtual private network (VPN), or a leased line or a combination of them. The communication network NW is configured by a combination of a network using wired communication and a network using wireless communication. Examples of short-range wireless communication standards include Bluetooth (registered trademark) low energy (BLE), near field communication (NFC), ultra wideband (UWB), and WiFi (registered trademark).

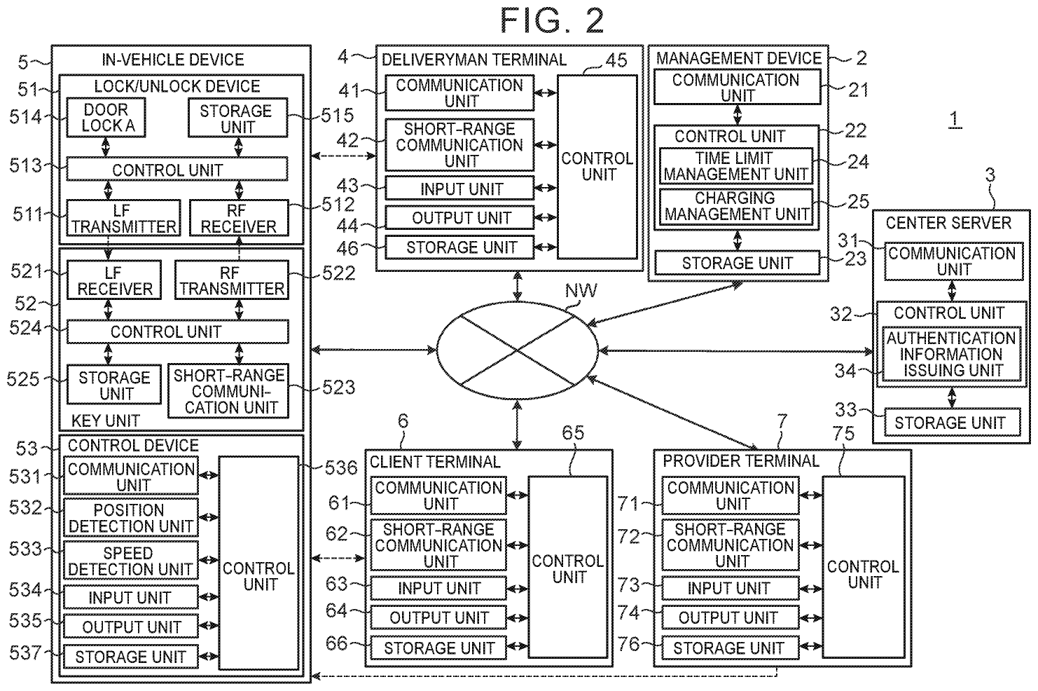

FIG. 2 is a block diagram showing a functional configuration of the collection/delivery system 1. A functional configuration for each component of the collection/delivery system 1 will be described below.

<Management Device 2>

The management device 2 includes a communication unit 21, a control unit 22, and a storage unit 23.

The communication unit 21 is an interface that communicates with the center server 3, deliveryman terminal 4, client terminal 6, and provider terminal 7 via the communication network NW.

The control unit 22 includes a time limit management unit 24 and a charging management unit 25. The time limit management unit 24 manages the storage time limit of a package delivered to the vehicle cabin of the vehicle 11. The charging management unit 25 performs charging processing for a client who has not yet collected a package even after the storage time limit of the package has passed.

The control unit 22 is a processor configured by a piece of hardware alone or by a combination of pieces of hardware. The hardware is a general-purpose processor such as a central processing unit (CPU) or a dedicated integrated circuit that performs a specific function such as a field programmable gate array (FPGA). The control unit 22 reads various programs from the storage unit 23 to perform various types of arithmetic processing for operating the management device 2.

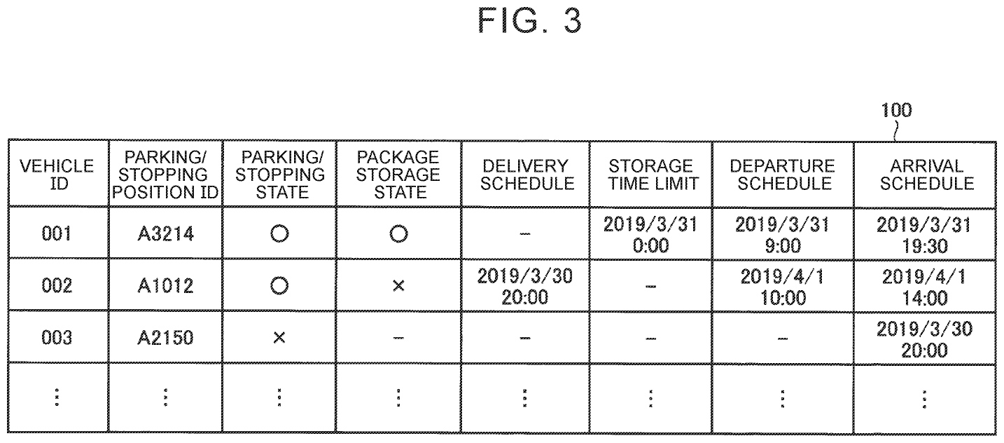

The storage unit 23 stores the parking/stopping information that includes the information about the position and the parking/stopping state of the vehicle 11 the vehicle cabin of which can be used as a package receiving space. FIG. 3 is a diagram schematically showing the parking/stopping information stored in the storage unit 23. A table 100 shown in the figure includes, for each vehicle, the vehicle ID, parking/stopping position ID, parking/stopping state, package storage state, package delivery schedule, package storage time limit, and departure schedule and arrival schedule of the vehicle 11. The parking/stopping state is updated based on the position information sent from the in-vehicle device 5. The storage time limit is registered based on the information sent from the provider terminal 7. The departure schedule and arrival schedule are registered based on the schedule information sent from the provider terminal 7. For example, the vehicle 11 with the vehicle ID 001 (hereinafter referred to as vehicle 001) is parked/stopped at a position indicated by the parking position ID A3214 and a package is currently stored in the vehicle cabin. The storage time limit of the package in the vehicle 001 is 0:00 on Mar. 31, 2019. In addition, the vehicle 001 is scheduled to leave the parking/stopping position at 9:00 on Mar. 31, 2019 and arrive at the parking/stopping position at 19:30 on the same day. The parking/stopping information may be stored, not in the storage unit 23, but in a device other than the management device 2.

The storage unit 23 further stores the collection/delivery information on the collection/delivery of a package, the charging information on charging performed by the charging management unit 25, and various programs for performing the operation of the management device 2. The collection/delivery information includes the information on a client, the information on the package type, collection/delivery time, deliveryman, and the information on the vehicle 11 used as the collection/delivery destination. The charging information includes the information on a client who is to pay, charging amount, and the like. Various programs include the management program used by the management device 2 to send a reconfirmation notification, which notifies about the storage time limit, to the client terminal 6.

The storage unit 23 is configured by a volatile memory such as a random access memory (RAM) and a nonvolatile memory such as a read only memory (ROM). The storage unit 23 may also be configured by a computer-readable recording medium such as a memory card that can be externally mounted. Various programs stored in the storage unit 23 can be recorded on a computer-readable recording medium, such as a hard disk, a flash memory, a CD-ROM, a DVD-ROM, or a flexible disk, for broader distribution.

<Center Server 3>

The center server 3 is an authentication management device that manages the authentication information used to authenticate a plurality of vehicles 11. The center server 3 includes a communication unit 31, a control unit 32, and a storage unit 33.

The communication unit 31 is an interface that communicates with the management device 2 via the communication network NW.

The control unit 32 has an authentication information issuing unit 34. The authentication information issuing unit 34 issues the authentication information for locking or unlocking the vehicle 11. When an authentication information issuance request for locking or unlocking the vehicle 11 is received from the deliveryman terminal 4 or the client terminal 6 via the management device 2, the authentication information issuing unit 34 sends the authentication information, corresponding to a key unit 52, back to the deliveryman terminal 4 or the client terminal 6 via the management device 2. The authentication information issuing unit 34 may generate authentication information including the information on an expiration date.

The control unit 32 is a processor configured by a piece of hardware alone such as a CPU or FPGA or by a combination of them. The control unit 32 reads various programs from the storage unit 33 to perform various types of arithmetic processing for operating the center server 3.

The storage unit 33 stores the information necessary for the authentication information issuing unit 34 to issue authentication information and various programs for performing the operations of the center server 3. The storage unit 33 is configured by a RAM, a ROM, and the like.

<Deliveryman Terminal 4>

The deliveryman terminal 4 includes a communication unit 41, a short-range communication unit 42, an input unit 43, an output unit 44, a control unit 45, and a storage unit 46. The deliveryman terminal 4, which is a terminal associated with a deliveryman of a package, is a carried by the deliveryman. The deliveryman terminal 4 is configured, for example, by a smartphone, a mobile phone, a tablet terminal, a personal information terminal, a wearable computer, or the like.

The communication unit 41 is an interface that communicates with at least the management device 2 via the communication network NW.

The short-range communication unit 42 is an interface that performs short-range wireless communication with the in-vehicle device 5. The short-range communication unit 42 performs short-range wireless communication based on any of the above-mentioned standards such as BLE, NFC, UWB, and WiFi (registered trademark).

The input unit 43 is configured by a user interface such as a keyboard, buttons, levers, a touch panel provided on the display that serves as the output unit 44, and a microphone for voice input. The input unit 43 accepts an input of various types of information.

The output unit 44 is configured by a display for displaying information using a liquid crystal display or organic electro luminescence (EL) display, a speaker for voice output, and the like.

The control unit 45 controls the operation of the deliveryman terminal 4. The control unit 45 is a processor configured by a piece of hardware alone such as a CPU or FPGA or by a combination of them. The control unit 45 reads various programs from the storage unit 46 to perform various types of arithmetic processing for operating the deliveryman terminal 4.

The storage unit 46 stores various programs for performing the operations of the deliveryman terminal 4. The storage unit 46 is configured by a RAM, a ROM, and the like.

The deliveryman terminal 4 may further include a capturing unit configured by an image sensor such as a CCD or a CMOS. In this case, the deliveryman uses the deliveryman terminal 4 to capture the vehicle cabin and send the captured image data to the management device 2. Based on the received image data, the management device 2 performs image recognition to recognize whether there is a space in the vehicle cabin for receiving a package.

In addition, an application that displays the parking/stopping information on the vehicle 11 may be provided as an application downloadable by the deliveryman terminal 4.

<In-Vehicle Device 5>

The in-vehicle device 5 is mounted on the vehicle 11. The in-vehicle device 5 includes a lock/unlock device 51, the key unit 52, and a control device 53. The in-vehicle device 5 performs a series of processing for locking or unlocking the vehicle 11 as follows: that is, the in-vehicle device 5 receives the authentication information from the deliveryman terminal 4, client terminal 6, or provider terminal 7, performs the authentication processing through the key unit 52 based on the received authentication information, and activates the lock/unlock device 51. In addition, the control device 53 of the in-vehicle device 5 detects the position and the movement state of the vehicle 11 and sends the detected information to the management device 2 via the communication network NW. An expiration date is included in the authentication information sent from the deliveryman terminal 4 and the client terminal 6. In other words, the deliveryman terminal 4 and the client terminal 6 need to obtain the authentication information from the center server 3 for each collection/delivery of a package. On the other hand, the provider terminal 7 stores the master authentication information with no expiration date.

The lock/unlock device 51 is a device for locking or unlocking the doors of the vehicle 11. The lock/unlock device 51 includes an LF transmitter 511, an RF receiver 512, a control unit 513, a door lock actuator 514, and a storage unit 515. In FIG. 2, the door lock actuator is indicated as “door lock A”.

The LF transmitter 511 sends a radio wave in a low frequency band (for example, 100 KHz to 300 KHz) for searching for (polling) the key unit 52. The LF transmitter 511 is built, for example, near the center console or the steering wheel in the vehicle cabin.

The RF receiver 512 receives radio waves (lock/unlock signal) in a high frequency band (for example, 100 MHz to 1 GHz) sent from the key unit 52. The RF receiver 512 is installed anywhere in the vehicle cabin.

The control unit 513 compares the key ID, included in the lock/unlock signal received from the key unit 52, with the key ID stored in the storage unit 515. When it is determined that the received key ID is valid, the control unit 513 sends the signal to the door lock actuator 514 to lock or unlock the doors of the vehicle 11 whose vehicle cabin is used for receiving a package.

The control unit 513 is configured by a piece of hardware alone such as a CPU or FPGA or by a combination of them. The control unit 513 may be configured by a plurality of electric control units (ECUs) connected communicably to each other via a vehicle network such as a controller area network (CAN). In the description below, the lock signal and the unlock signal are sometimes collectively referred to as the lock/unlock signal.

The door lock actuator 514 is an actuator that locks or unlocks the doors of the vehicle 11. The door lock actuator 514 operates based on the lock/unlock signal sent from the control unit 513. The door lock actuator 514 may lock and unlock each door of the vehicle 11 independently. For example, when the trunk is used as the vehicle cabin for receiving a package, the door lock actuator 514 may lock/unlock only the trunk.

The storage unit 515 stores various information including the key ID of the vehicle door and various programs for operating the lock/unlock device 51. The storage unit 515 is configured by a RAM, a ROM, and the like.

The key unit 52 includes an LF receiver 521, an RF transmitter 522, a short-range communication unit 523, a control unit 524, and a storage unit 525. The key unit 52 is arranged in a predetermined position, for example, in the glove box in the vehicle cabin of the vehicle 11.

The LF receiver 521 receives the polling signal sent from the lock/unlock device 51 via radio waves in a low frequency band. The LF receiver 521 has an antenna (hereinafter referred to as LF antenna) for receiving radio waves in a low frequency band.

The RF transmitter 522 sends the lock/unlock signal to the lock/unlock device 51 via radio waves in a high frequency band.

The short-range communication unit 523 is a communication interface that performs short-range wireless communication with the deliveryman terminal 4, the client terminal 6, or the provider terminal 7.

The control unit 524 controls the operation of the key unit 52. The control unit 524 compares the authentication information, included in a lock request or an unlock request received from the deliveryman terminal 4, the client terminal 6, or the provider terminal 7, with the authentication information stored in the storage unit 525. When these pieces of authentication information are in a predetermined relationship, it is determined that the authentication is successful. The predetermined relationship here refers to one of the following three relationships: (1) a relationship in which the authentication information stored in the storage unit 525 matches the authentication information received from the deliveryman terminal 4, the client terminal 6, or the provider terminal 7, (2) a relationship in which the results of predetermined encryption/decryption processing for the two pieces of authentication information match, and (3) a relationship in which the result of decryption processing for one of the two pieces of authentication information matches the other piece of authentication.

When the deliveryman terminal 4, the client terminal 6, or the provider terminal 7 is successfully authenticated, the control unit 524 sends the lock/unlock signal, generated in response to the request received from the deliveryman terminal 4, the client terminal 6, or the provider terminal 7, to the lock/unlock device 51 via the RF transmitter 522.

The control unit 524 is configured by a piece of hardware alone such as a CPU or FPGA or by a combination of them.

The storage unit 525 stores the authentication information for authenticating the deliveryman terminal 4, the client terminal 6, or the provider terminal 7, as well as the key ID. The storage unit 525 may store an encrypted key ID. When the storage unit 525 stores an encrypted key ID, the control unit 524 receives the decryption information from the deliveryman terminal 4, the client terminal 6 or the provider terminal 7 and, based on the received decryption information, decrypts the key ID.

The storage unit 525 stores various programs for performing the operation of the key unit 52. The storage unit 525 is configured by a RAM, a ROM, and the like. In the description below, the authentication information stored in the storage unit 525 is sometimes referred to as the device authentication information, and the authentication information sent by the deliveryman terminal 4, the client terminal 6 or the provider terminal 7 is sometimes referred to as the terminal authentication information.

The key unit 52 having the configuration described above communicates with the lock/unlock device 51 of the in-vehicle device 5, making it possible to lock and unlock the vehicle 11 without using a physical key.

The control device 53 includes a communication unit 531, a position detection unit 532, a speed detection unit 533, an input unit 534, an output unit 535, a control unit 536, and a storage unit 537.

The communication unit 531 is an interface that communicates with the management device 2 via the communication network NW. The communication unit 531 sends the position information and speed information on the vehicle 11 to the management device 2.

The position detection unit 532 is configured, for example, by a global positioning system (GPS) sensor that receives GPS signals sent by the GPS satellites. Based on the received signals, the position detection unit 532 detects the position information (including latitude and longitude) on the vehicle 11 and outputs the detected position information to the control unit 536. Note that, as a method for detecting the position information on the vehicle 11, the position detection unit 532 may employ a method in which LiDAR (Light Detection and Ranging, Laser Imaging Detection and Ranging) and a three-dimensional digital map are combined.

The speed detection unit 533 is configured, for example, by a vehicle speed sensor. The speed detection unit 533 detects the information on the speed of the vehicle 11 and outputs the detected speed to the control unit 536.

The position detection unit 532 and the speed detection unit 533 may detect the position information and the speed information via mobile communication that conforms to the communication standard such as 3G, 4G, 5G, or Long Term Evolution (LTE). In this case, the position information and the speed information may be detected via mobile communication with other vehicles, with various sensors provided around the road on which the vehicle is traveling, and with the server that acquires the information from these vehicles and various sensors.

The input unit 534 and the output unit 535 have the functional configuration similar to that of the input unit 43 and the output unit 44 described above. The input unit 534 can also accept an input of schedule information on the vehicle 11 from the provider of the vehicle 11. The schedule information on the vehicle 11 mentioned here includes the date and time when the vehicle 11 leaves the area and the date and time when the vehicle 11 arrives at the area. The schedule information may include the information on whether the vehicle cabin of the vehicle 11 that is parked or stopped in the area can be used for storing a package.

The control unit 536 controls the operation of the control device 53. The control unit 536 is a processor configured by a piece of hardware alone such as a CPU or FPGA or by a combination of them. The control unit 536 reads various programs from the storage unit 537 to perform various types of arithmetic processing for operating the control device 53.

The storage unit 537 stores various types of information including the detection results detected by the position detection unit 532 and the speed detection unit 533 and various programs for performing the operation of the control device 53. The storage unit 537 is configured by a RAM, a ROM, and the like.

The in-vehicle device 5 may further include an in-vehicle camera or a weight sensor as a unit for confirming whether there is a space in the vehicle cabin for receiving a package. In this case, the in-vehicle device 5 sends the image data, captured by the in-vehicle camera, to the management device 2. Based on the received image data, the management device 2 performs image recognition to recognize whether there is a space in the vehicle cabin for receiving a package. The in-vehicle camera may capture the image only while the vehicle cabin key is unlocked.

Furthermore, a reader that can read the information recorded on a recording medium (such as a two-dimensional code) may be provided in the vehicle cabin. In this case, a recording medium, which is read by the reader, is attached to the packaging material of a package. When a package is stored in a predetermined position in the vehicle cabin, this configuration allows the reader to read the information recorded on the recording medium and send the information to the management device 2 to notify that the package has been stored in the vehicle cabin.

<Client Terminal 6>

The client terminal 6 has a functional configuration similar to that of the deliveryman terminal 4. More specifically, the client terminal 6 includes a communication unit 61, a short-range communication unit 62, an input unit 63, an output unit 64, a control unit 65, and a storage unit 66. The functional configurations of the communication unit 61, short-range communication unit 62, input unit 63, output unit 64, control unit 65, and storage unit 66 are similar to those of the communication unit 41, short-range communication unit 42, and input unit 43, output unit 44, control unit 45, and storage unit 46, respectively.

<Provider Terminal 7>

The provider terminal 7 has a functional configuration similar to that of the deliveryman terminal 4. More specifically, the provider terminal 7 includes a communication unit 71, a short-range communication unit 72, an input unit 73, an output unit 74, a control unit 75, and a storage unit 76. The functional configurations of the communication unit 71, short-range communication unit 72, input unit 73, output unit 74, control unit 75, and storage unit 76 are similar to those of the communication unit 41, short-range communication unit 42, input unit 43, output unit 44, control unit 45, and storage unit 46, respectively. The input unit 73, one of those units, accepts an input of schedule information on the vehicle 11 from the provider of the vehicle 11. The storage unit 76 stores the master authentication information that can be authenticated by the key unit 52. Therefore, the provider can use the provider terminal 7 to lock and unlock the vehicle 11 at any time.

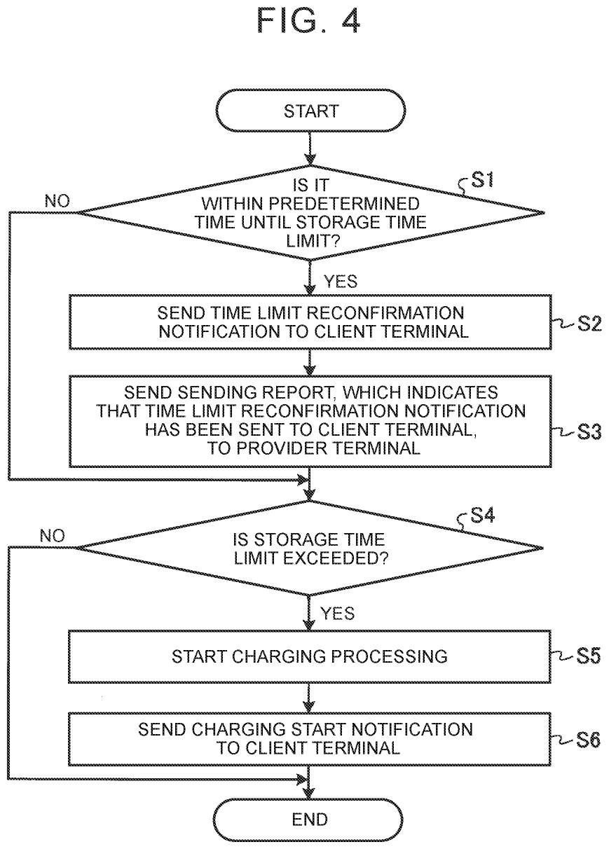

FIG. 4 is a flowchart showing an outline of processing performed by the management device 2. FIG. 4 shows an outline of processing for one vehicle 11 (for example, vehicle 001 in FIG. 3) that is parked/stopped with a package stored in the vehicle cabin.

First, the time limit management unit 24 confirms whether it is within a predetermined time until the storage time limit of the package (step S1). When it is determined as the result of the confirmation that it is within a predetermined time until the storage time limit of the package (step S1: Yes), the communication unit 21 sends a time limit reconfirmation notification to the client terminal 6 under the control of the control unit 22 (step S2) and, then, sends a sending report, which indicates that the time limit reconfirmation notification has been sent to the client terminal 6, to provider terminal 7 (step S3). Note that step S2 and step S3 may be processed in any order or may be processed concurrently.

Next, the time limit management unit 24 determines whether the storage time limit of the package is exceeded (step S4). When it is determined as the result of the determination that the storage time limit is exceeded (step S4: Yes), the charging management unit 25 starts charging processing for the client of the package (step S5) and sends a charging start notification to the client terminal 6 associated with the client (step S6).

When it is determined as the result of the determination in step S4 that the storage time limit is not exceeded (step S4: No), the management device 2 ends a series of processing.

In step S1, when it is determined as the result of the confirmation that it is not within a predetermined time until the storage time limit (step S1: No), the processing of the management device 2 proceeds to step S4.

The management device 2 repeatedly performs the processing in steps S1 to S6 at a predetermined cycle for the vehicle 1 in which the package is stored.

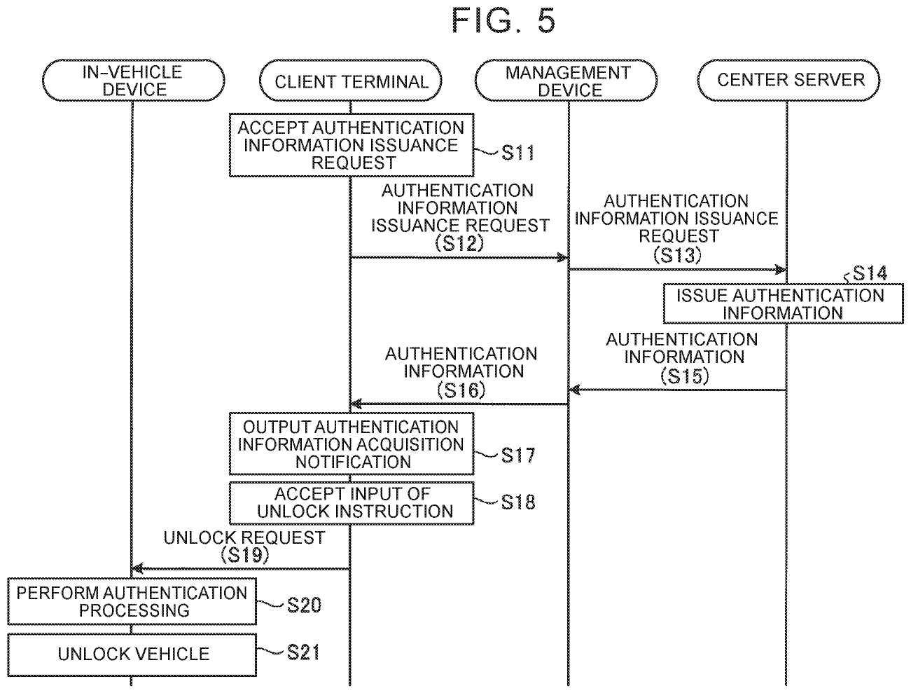

FIG. 5 is a sequence diagram showing an outline of processing performed by the collection/delivery system 1 after the management device 2 sends a charging start notification to the client terminal 6. FIG. 5 shows the processing until the client terminal 6 unlocks the vehicle 11 in which a package is stored.

First, when the input unit 63 of the client terminal 6 accepts an input of an authentication information issuance request from the client (step S11), the communication unit 61 sends the authentication information issuance request to the management device 2 under the control of the control unit 65 (step S12). The authentication information issuance request, sent by the communication unit 61, includes the information on the vehicle 11 that is the delivery destination and the terminal information on the client terminal 6.

In the management device 2 that has received the authentication information issuance request from the client terminal 6, the communication unit 21 sends the authentication information issuance request to the center server 3 under the control of the control unit 22 (step S13).

In the center server 3 that has received the authentication information issuance request, the authentication information issuing unit 34 issues authentication information based on the authentication information issuance request (step S14). At this time, the authentication information issuing unit 34 issues the authentication information when it is determined that the vehicle 11 to be authenticated is a vehicle in which the package is correctly stored and that the client terminal 6 is a terminal having a legitimate authority.

After that, the communication unit 31 sends the authentication information to the management device 2 under the control of the control unit 32 (step S15).

The communication unit 21 of the management device 2 that has received the authentication information from the center server 3 sends the received authentication information to the client terminal 6 under the control of the control unit 22 (step S16).

In the client terminal 6 that has received the authentication information from the management device 2, the output unit 64 outputs an authentication information acquisition notification (step S17). After that, when the input unit 63 accepts an input of the unlock instruction from the deliveryman (step S18), the short-range communication unit 62 sends an unlock request, which includes the authentication information, to the in-vehicle device 5 of the vehicle 11 to be unlocked (step S19). To perform the processing in step S19, it is necessary for the client terminal 6 to be present in a range where the client terminal 6 can communicate with the in-vehicle device 5 of the vehicle 11 to be unlocked.

In the in-vehicle device 5, the key unit 52 that has received the unlock request performs the authentication processing (step S20). More specifically, after the short-range communication unit 523 receives the unlock request, the control unit 524 performs the authentication processing by comparing the authentication information (terminal authentication information) included in the unlock request and the authentication information (device authentication information) stored in the storage unit 525. When the authentication is successful, the control unit 524 causes the RF transmitter 522 to send the unlock signal that includes the key ID.

When the RF receiver 512 of the lock/unlock device 51 receives the unlock signal, the lock/unlock device 51 unlocks the vehicle 11 whose vehicle cabin is used for receiving the package (step S21). More specifically, the control unit 513 first compares the key ID included in the unlock signal with the key ID stored in the storage unit 515. When the key ID comparison is successful, the control unit 513 causes the door lock actuator 514 to unlock the vehicle 11 whose vehicle cabin is used for receiving the package. At this time, the lock/unlock device 51 may send an answerback to the key unit 52.

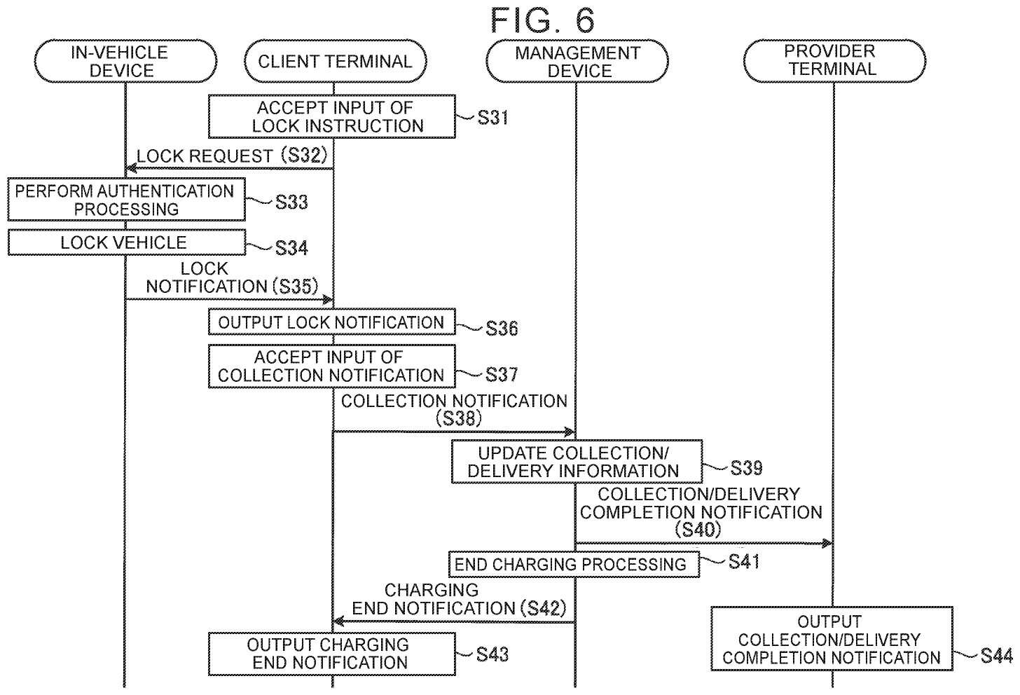

FIG. 6 is a sequence diagram showing an outline of processing performed by the collection/delivery system 1 and showing an outline of processing of locking the vehicle 11 after a client collects a package.

First, when the input unit 63 of the client terminal 6 accepts an input of the lock instruction from the client (step S31), the short-range communication unit 62 sends the lock request to the in-vehicle device 5 of the vehicle 11 to be locked under the control of the control unit 65 (step S32). To perform the processing in step S32, it is necessary for the client terminal 6 to be present within a range where the client terminal 6 can communicate with the in-vehicle device 5 of the vehicle 11 to be locked.

In the in-vehicle device 5, the key unit 52 that has received the lock request performs the authentication processing (step S33). More specifically, after the short-range communication unit 523 receives the lock request, the control unit 524 performs the authentication processing by comparing the authentication information (terminal authentication information) included in the lock request with the authentication information (device authentication information) stored in the storage unit 525. When the authentication is successful, the control unit 524 causes the RF transmitter 522 to send the lock signal that includes the key ID.

When the RF receiver 512 of the lock/unlock device 51 receives the lock signal, the lock/unlock device 51 locks the vehicle 11 whose vehicle cabin is used for receiving the package (step S34). More specifically, the control unit 513 first compares the key ID included in the lock signal with the key ID stored in the storage unit 515. When the key ID comparison is successful, the control unit 513 causes the door lock actuator 514 to lock the vehicle 11 whose vehicle cabin is used for receiving the package.

Next, the in-vehicle device 5 sends the lock notification signal to the client terminal 6 (step S35). The detail of the processing at this time is as follows. First, the LF transmitter 511 of the lock/unlock device 51 sends the lock notification signal to the key unit 52. In the key unit 52 that has received the lock notification signal, the short-range communication unit 523 sends the lock notification signal to the client terminal 6 under the control of the control unit 524. In this case, too, it is necessary for the client terminal 6 to be present in a range where the client terminal 6 can communicate with the in-vehicle device 5.

In the client terminal 6 that has received the lock notification signal, the output unit 64 outputs the lock notification (step S36). Next, when the input unit 63 accepts an input of the collection notification from the client (step S37), the communication unit 61 sends the collection notification to the management device 2 under the control of the control unit 65 (step S38).

In the management device 2 that has received the collection notification, the control unit 22 updates the collection/delivery information and the parking/stopping information in the storage unit 23 (step S39). After that, the communication unit 21 of the management device 2 sends the collection/delivery completion notification to the provider terminal 7 under the control of the control unit 22 (step S40).

In the management device 2, the charging management unit 25 ends the charging processing (step S41). At this time, the charging management unit 25 determines the amount to be charged to the client. After that, the communication unit 21 of the management device 2 sends the charging end notification to the client terminal 6 under the control of the control unit 22 (step S42). The charging end notification includes the information on the charging amount. Note that the order of the processing in steps S39 to S41 may be changed as appropriate.

The output unit 64 of the client terminal 6 outputs the information on the received charging end notification (step S43).

The output unit 74 of the provider terminal 7 outputs the information on the received collection/delivery completion notification (step S44).

According to the first embodiment described above, a reconfirmation notification on a storage time limit is sent to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package. Therefore, this configuration allows the client to be aware that the package storage time limit approaches, making it possible for the client to deal appropriately with a situation in which the storage time limit approaches.

In addition, the configuration according to the first embodiment allows a person who does not own a vehicle to use another person's vehicle cabin and, at the same time, allows a person who owns but rarely uses a vehicle to use the vehicle more effectively.

(Modification)

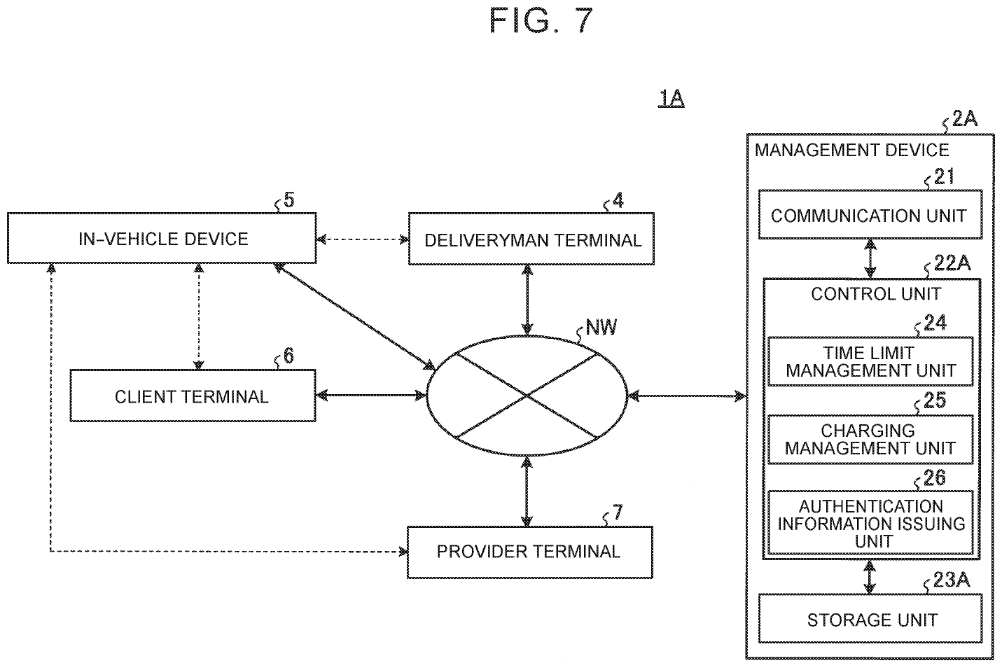

FIG. 7 is a block diagram showing a functional configuration of a collection/delivery system including a management device according to a modification of the first embodiment. A collection/delivery system 1A shown in the figure includes a management device 2A, a deliveryman terminal 4, an in-vehicle device 5, and a client terminal 6. In this modification, the management device 2A has the functions of a management device and an authentication management device. For this reason, the collection/delivery system 1A does not have a center server.

The functional configuration of the management device 2A will be described. The management device 2A includes a communication unit 21, a control unit 22A, and a storage unit 23A.

The control unit 22A includes a time limit management unit 24, a charging management unit 25, and an authentication information issuing unit 26. As with the authentication information issuing unit 34 described above, the authentication information issuing unit 26 issues authentication information for locking or unlocking the vehicle 11. The detail of the processing of the authentication information issuing unit 26 is the same as the detail of the processing of the authentication information issuing unit 34 described above.

The control unit 22A is a processor configured by a piece of hardware alone such as a CPU or FPGA or by a combination of them. The control unit 22A reads various programs from the storage unit 23A to perform various types of arithmetic processing.

The storage unit 23A stores the parking/stopping information similar to the parking/stopping information stored in the storage unit 23 as well as the information required when the authentication information issuing unit 26 issues authentication information. The storage unit 23A is configured by a RAM, a ROM, and the like.

The modification of the first embodiment described above achieves the effect similar to that of the first embodiment and, in addition, implements effective management since collection/delivery management and locking/unlocking management are collectively performed.

### Second Embodiment

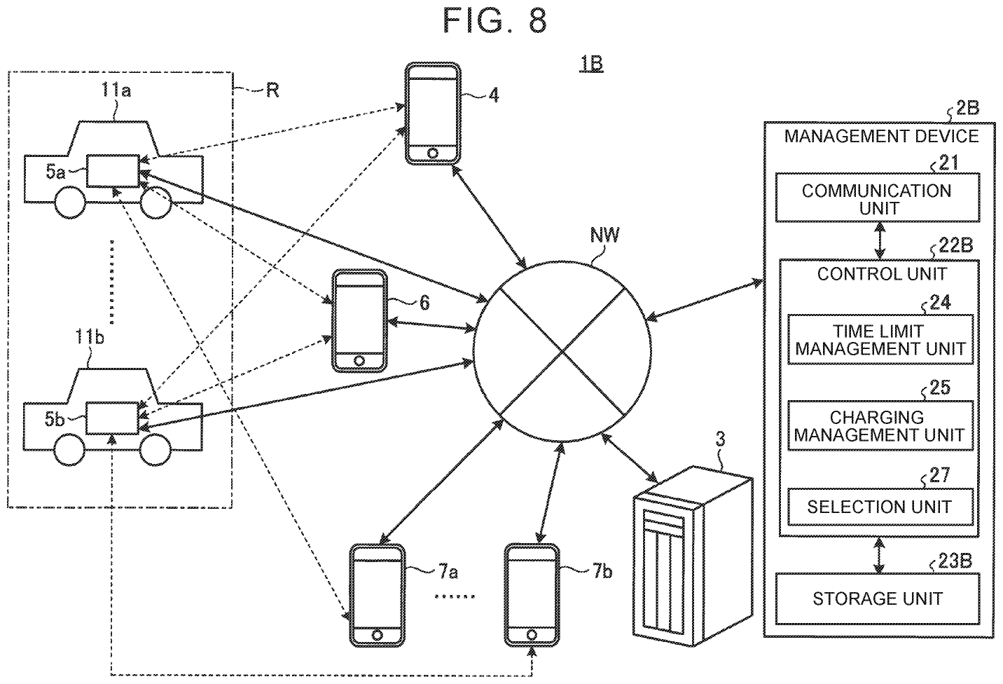

FIG. 8 is a diagram showing a functional configuration of a collection/delivery system that includes a management device according to a second embodiment. In FIG. 8, a management device 2B is shown as a block diagram. A collection/delivery system 1B shown in FIG. 8 is a system in which packages are collected/delivered using the vehicle cabins of a plurality of vehicles 11. These vehicles are parked or stopped in a predetermined area R and are registered in advance as package receiving vehicles. The area R is an area including but not limited to a closed area, such as a parking lot, where a plurality of vehicles 11 registered in advance are parked.

The collection/delivery system 1B includes the management device 2B, a center server 3, a deliveryman terminal 4, a plurality of in-vehicle devices 5 each mounted on one of the plurality of vehicles 11, a client terminal 6, and a plurality of provider terminals 7 associated with a plurality of providers each of whom has one of the plurality of vehicles 11 and provides its vehicle cabin for receiving a package. In the description below, two of the plurality of vehicles 11 are referred to as vehicles 11a and 11b to distinguish the two vehicles, and the in-vehicle devices mounted on the vehicles 11a and 11b are referred to as in-vehicle devices 5a and 5b. The provider terminals associated with the in-vehicle devices 5a and 5b are referred to as provider terminals 7a and 7b. Furthermore, the components of the provider terminal 7a are referred to as a communication unit 71a and so on, and the components of the provider terminal 7b are referred to as a communication unit 71b and so on.

The management device 2B includes a communication unit 21, a control unit 22B, and a storage unit 23B. The control unit 22B includes a time limit management unit 24, a charging management unit 25, and a selection unit 27. The selection unit 27 selects a vehicle to be used for the collection/delivery of a collection/delivery package based on the parking/stopping information. The parking/stopping information includes the information on the parking/stopping positions and the parking/stopping periods of a plurality of vehicles 11 which can be parked or stopped in the area R and whose vehicle cabins can be provided for receiving packages. In addition, in response to a transfer request from the provider terminal 7 associated with the vehicle 11 that is parked in the area R and stores a package, the selection unit 27 selects the vehicle 11 that is parked in the same area R and is a candidate for the transfer destination.

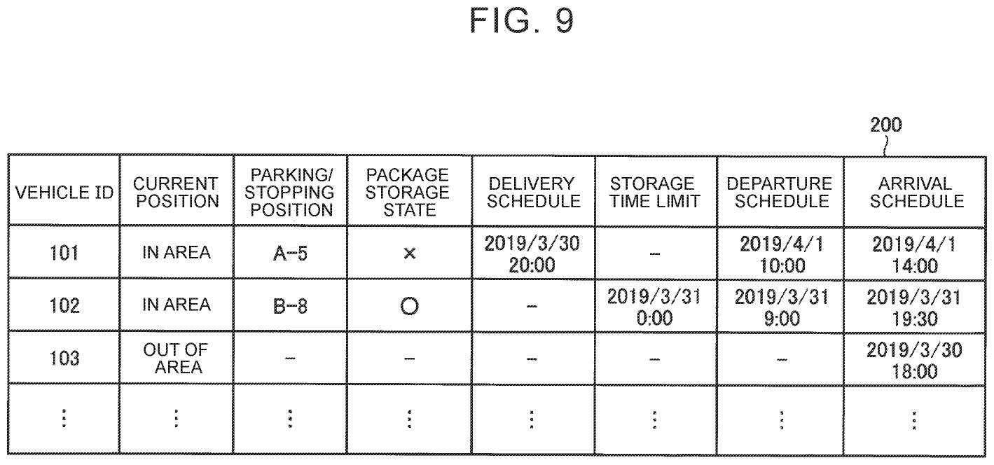

FIG. 9 is a diagram schematically showing the parking/stopping information stored in the storage unit 23B. A table 200 shown in the figure includes, for each vehicle, the vehicle ID, current position, parking/stopping position in the area R, package storage state, package delivery schedule, package storage time limit, departure schedule, and arrival schedule. The current position and the parking/stopping position are registered based on the position information sent from the in-vehicle device 5. The delivery schedule is registered based on the information sent from the client terminal 6. The departure schedule and the arrival schedule are registered based on the schedule information sent from the provider terminal 7. For example, the vehicle 11 with the vehicle ID 102 (hereinafter referred to as vehicle 102) is parked/stopped at the position B-8 in the area R with a package currently stored in the vehicle cabin. The storage time limit of the package in the vehicle 102 is 0:00 on Mar. 31, 2019. The vehicle 102 is scheduled to leave the area R at 9:00 on Mar. 31, 2019 and arrive at the area R at 19:30 on the same day. The parking/stopping information may be stored, not in the storage unit 23B, but in a device other than the management device 2B.

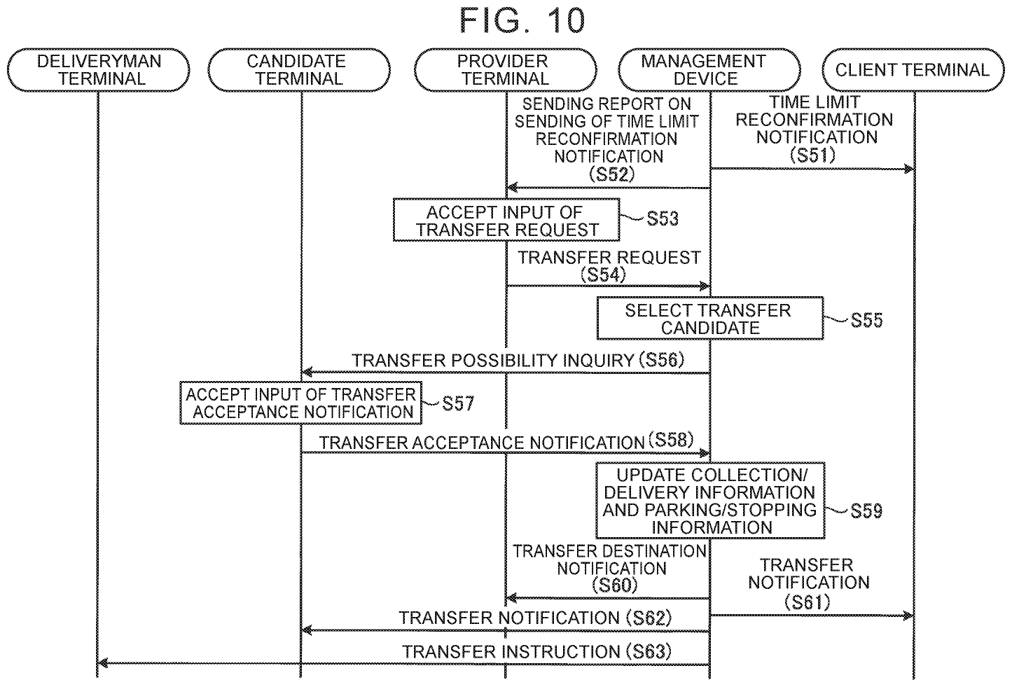

FIG. 10 is a sequence diagram showing an outline of processing performed by the collection/delivery system 1B. FIG. 10 shows an outline of processing in which, when a plurality of vehicles are parked/stopped in the area R and are registered as package receiving vehicles, a package in one of the vehicles is not yet collected when it is within a predetermined time until the storage time limit and the provider of that vehicle requests to transfer the package to one of the other vehicles 11. In the description below, the vehicle owned by the provider who requests the transfer is the vehicle 11a.

First, the communication unit 21 of the management device 2B sends a time limit reconfirmation notification to the client terminal 6 (step S51) under the control of the control unit 22 and, at the same time, sends a sending report, which indicates that the time limit reconfirmation notification has been sent to the client terminal 6, to provider terminal 7a (step S52).

After that, when the input unit 73a of the provider terminal 7a accepts an input of the package transfer request from the provider (step S53), the communication unit 71a sends the transfer request to the management device 2B under the control of the control unit 75a (step S54).

The management device 2B, which has received the transfer request, reads the parking/stopping information on the plurality of the vehicles 11, parked/stopped in the area R, from the storage unit 23B, and selects a transfer candidate vehicle based on the parking/stopping information and the transfer request (step S55). In the description below, it is assumed that the selected transfer candidate vehicle is the vehicle 11b. The provider of the vehicle 11b is referred to as a “candidate”, and the provider terminal 7b as a “candidate terminal 7b”.

Next, the communication unit 21 sends a transfer possibility inquiry to the candidate terminal 7b corresponding to the vehicle 11b selected by the selection unit 27 under the control of the control unit 22B (step S56).

When the input unit 73b of the candidate terminal 7b accepts an input of the transfer acceptance notification from the candidate (step S57), the communication unit 71b sends the transfer acceptance notification to the management device 2B (step S58).

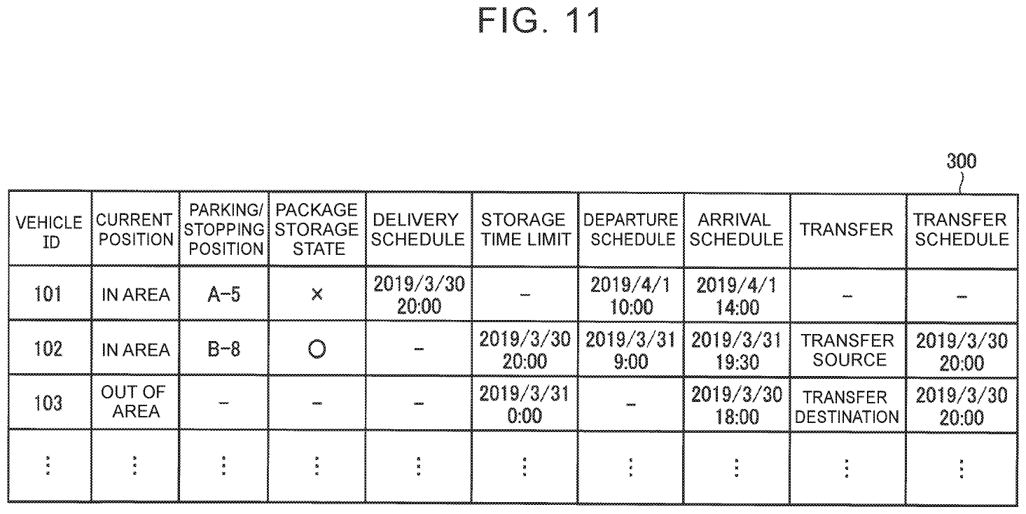

The management device 2B, which has received the transfer acceptance notification, updates the collection/delivery information and the parking/stopping information (step S59). FIG. 11 is a diagram schematically showing the updated parking/stopping information. A table 300 shown in FIG. 11 is obtained by updating the parking/stopping information in the table 200 shown in FIG. 9. More specifically, the two items, “transfer” and “transfer schedule”, are added to the table 300. In the table 300, the vehicle ID of the transfer source vehicle 11a is 102, the vehicle ID of the transfer destination vehicle 11b is 103, and the transfer schedule is 20:00 on Mar. 30, 2019. In addition, in the table 300, the storage time limit of the vehicle 11a is changed to 20:00 on Mar. 30, 2019, which is the same as the transfer schedule, and the storage time limit of the vehicle 11b is set to the original storage time limit 0:00 on Mar. 31, 2019.

After step S59, under the control of the control unit 22, the communication unit 21 sends the transfer destination notification to the provider terminal 7a (step S60), sends the transfer notification to the client terminal 6 and the candidate terminal 7b (steps S61 and S62), and sends the transfer instruction to the deliveryman terminal 4 (step S63). Note that steps S60 to S63 may be performed in any order.

After that, the deliveryman moves the package, stored in the vehicle cabin of the vehicle 11a, to the vehicle cabin of the vehicle 11b according to the transfer instruction. At this time, the unlock and lock processing performed by the deliveryman terminal 4 is the same as the unlock and lock processing described as the processing performed by the client terminal 6 in the first embodiment (see FIG. 5 and FIG. 6). After the vehicle 11b is locked, the communication unit 41 of the deliveryman terminal 4 sends the transfer completion notification, which is accepted by the input unit 43, to the management device 2B. Then, in the management device 2B, the control unit 22B updates the collection/delivery information and parking/stopping information stored in the storage unit 23B and causes the communication unit 21 to send the transfer completion report to the client terminal 6, provider terminal 7a, and candidate terminal 7b.

According to the second embodiment described above, it is possible to deal appropriately with a situation in which the storage time limit of a package approaches as in the first embodiment.

In addition, according to the second embodiment, when a plurality of vehicles registered as package receiving vehicles are parked/stopped in a predetermined area and when the storage time limit approaches but a package stored in one of the vehicles is not collected, the package can be transferred to one of the other vehicles. Therefore, this configuration ensures the effective use of a vehicle registered as a package receiving vehicle in a predetermined area and allows the provider to deal appropriately with a situation in which an abnormal situation is likely to occur.

In the second embodiment, too, the management device may include an authentication information issuing unit, as in the modification of the first embodiment described above.

In addition, the selection unit 27 may select the vehicle 11 to which a package is to be transferred by further referring to the collection/delivery condition information registered in advance for each vehicle 11. Examples of collection/delivery conditions include the package type, package weight, and package collection/delivery time zone.

In addition, with the past transfer history information stored in the storage unit 23, the selection unit 27 may refer to the transfer history information together with the parking/stopping information to select the vehicle 11 to which a package is to be transferred, for example, in the order of the number of times the vehicles 11 are selected as the transfer destination.

When multiple packages can be stored in one vehicle cabin, the storage unit 23B may store in advance a combination of package types that can be stored simultaneously so that the selection unit 27 can select the vehicle of the transfer destination based on the combination. For example, this prevents a situation in which a food material that is the source of odor and clothes into which the odor of the food should not preferably be absorbed are stored simultaneously in the same vehicle cabin.

Some rewards may be given to the vehicle 11 of a transfer destination. This encourages the provider of the vehicle 11 to accept a package transfer more actively.

### Other Embodiments

The embodiments for carrying out the present disclosure have been described above, but the present disclosure should not be limited only to the first and second embodiments described above. For example, when the vehicle cabin of a plurality of vehicles can be used for receiving packages in the predetermined area, a provider terminal may send a transfer request to the management device regardless of the storage time limit of a package. As a result, when a provider suddenly changes the schedule, the system can respond to such a situation more flexibly.

Instead of a collection/delivery system with one management device and one center server, the edge computing technique may be applied. The edge computing technique allows terminals, each capable of performing a part of the processing of the management device and the center server, to be distributed and arranged physically close to deliveryman terminals, making it possible to send and receive large amounts of data efficiently and reduce the processing time.

Further effects and modifications can be easily derived by those skilled in the art. The broader aspects of the present disclosure are not limited to the specific details and the typical embodiments expressed and described above. Accordingly, various modifications can be made without departing from the spirit or scope of the general inventive concept as defined by the appended claims and their equivalents.

What is claimed is:

1. A management device comprising:
a memory; and
a processor having at least one piece of hardware, wherein
the processor is configured to send a reconfirmation notification on a storage time limit to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package.

2. The management device according to claim 1, wherein
the processor is configured to start charging processing for the client when the storage time limit is exceeded while the vehicle stores the package.

3. The management device according to claim 1, wherein
the processor is configured to select a transfer candidate vehicle based on parking/stopping information and to send a transfer possibility inquiry to a candidate terminal associated with a provider of the selected transfer candidate vehicle when a transfer request for transferring the package is received from a provider terminal associated with a provider of the vehicle, the parking/stopping information including information on positions and parking/stopping states of a plurality of vehicles each of which can provide a vehicle cabin thereof for receiving other person's packages in the area.

4. The management device according to claim 3, wherein
the processor is configured to further refer to schedule information for selecting the transfer candidate vehicle, the schedule information registered by each of owners of the plurality of vehicles.

5. The management device according to claim 3, wherein
the memory is configured to store history information on past transfers and the processor is configured to further refer to the history information for selecting the transfer candidate vehicle.

6. The management device according to claim 3, wherein
the processor is configured to select the transfer candidate vehicle according to a type of the package.

7. The management device according to claim 3, wherein
the processor is configured to send a transfer instruction to a deliveryman terminal when a transfer acceptance notification is received from the candidate terminal, the transfer instruction including information on the transfer candidate vehicle, the deliveryman terminal associated with a deliveryman of the package.

8. A management method performed by a management device including a memory and a processor having at least one piece of hardware, the management method comprising:
sending a reconfirmation notification on a storage time limit to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package, the storage time limit being read from the memory.

9. A management program that causes a management device including a memory and a processor having at least one piece of hardware to execute:
sending a reconfirmation notification on a storage time limit to a client terminal associated with a client who has requested a delivery of a package when a vehicle that is parked or stopped in a predetermined area for providing a vehicle cabin thereof for receiving other person's packages stores the package and when it is within a predetermined time until the storage time limit of the package.
